(19) United States
(12) Patent Application Publication
(10) Pub. No.: US 2011/0041495 A1
(43) Pub. Date: Feb. 24, 2011

(54) SYSTEMS AND METHODS FOR EXHAUST GAS RECIRCULATION

(75) Inventor: James Henry Yager, North East, PA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: General Electric Company, Schenectady, NY (US)

(21) Appl. No.: 12/546,343

(22) Filed: Aug. 24, 2009

(51) Int. Cl. F02B 33/44; F02M 25/07

(52) U.S. Cl. 60/605.2; 123/568.12

(57) ABSTRACT

Exhaust gas recirculation systems and methods related to internal combustion engines are provided. In one embodiment, a system comprises an engine having at least a first cylinder group and a second cylinder group, with at least one cylinder in each cylinder group, an intake manifold having an inlet and a first outlet coupled to the first cylinder group and a second outlet coupled to the second cylinder group, an intake passage coupled to the intake manifold inlet, and first and second exhaust manifolds coupled to the first and second cylinder groups, respectively. An exhaust gas recirculation system is further coupled between the second exhaust manifold and the intake passage, and has a number of openings positioned within the intake passage, the number of openings equal to or greater than a number of cylinders having an intake event between successive exhaust events occurring in the second cylinder group.

### FIELD

The subject matter disclosed herein relates to exhaust gas recirculation (EGR) systems and methods, and more particularly to the introduction of the EGR gas into an engine intake.

### BACKGROUND

Engines may utilize recirculation of exhaust gas from the engine exhaust system to the engine intake system, a process referred to as Exhaust Gas Recirculation (EGR), to reduce regulated emissions and/or improve fuel economy.

In one approach, one or more cylinders are dedicated to generating EGR gasses delivered to the intake, where such cylinders may be referred to as donor cylinders. One example of such an approach is described in U.S. Pat. No. 4,249,382 to Evans et al. where only a portion of the pistons of an engine driven within the respective cylinders thereof will recirculate exhaust gas into the inlet manifold. In this example, as shown in FIG. 1 of Evans, the EGR gasses are introduced into a plurality of inlets in the intake manifold.

### BRIEF DESCRIPTION OF THE INVENTION

However, the inventor herein has identified limitations to the above described approach. For example, the location at which EGR is introduced into the intake of the engine may have significant effects on the mixing of EGR gases with fresh intake air, particularly when donor cylinders generate the EGR gases delivered to the intake. For example, based on the particular spacing between locations at which EGR is introduced, the number of donor cylinders, and/or the firing order of the engine, the above described approach may not achieve uniform mixing to all cylinders of an engine. Uneven mixing of EGR gases may degrade engine performance and lead to subsequent increased engine emissions.

Consequently, in one embodiment, a system includes an engine having at least a first cylinder group and a second cylinder group, with at least one cylinder in each cylinder group, an intake manifold having an inlet and a first outlet coupled to the first cylinder group and a second outlet coupled to the second cylinder group, an intake passage coupled to the intake manifold inlet, a first exhaust manifold coupled to the first cylinder group, a second exhaust manifold coupled to the second cylinder group, and an exhaust gas recirculation system. The exhaust gas recirculation system is coupled between the second exhaust manifold and the intake passage. The exhaust gas recirculation system has a number of openings positioned within the intake passage, wherein the number of openings is equal to or greater than a number of cylinders having an intake event between successive exhaust events occurring in the second cylinder group.

In another embodiment, a method includes delivering all exhaust gas from a donor cylinder group (having one or more cylinders) of the engine to a plurality of inlets upstream of the intake manifold. The method further comprises mixing intake air with the delivered exhaust gas, and inducting the mixed intake air/exhaust gas in each cylinder of the engine, including the one or more cylinders of the donor cylinder group. A number of the inlets is equal to or greater than a number of cylinders of the engine having induction events between successive donor cylinder exhaust events occurring in the donor cylinder group.

In this way, it is possible to provide uniform EGR distribution to all engine cylinders, even with varying inlet air and EGR flow to the engine.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure. Also, the inventor herein has recognized any identified issues and corresponding solutions.

### BRIEF DESCRIPTION OF THE DRAWINGS

The present invention will be better understood from reading the following description of non-limiting embodiments, with reference to the attached drawings, wherein below:

FIG. 1 schematically illustrates an example system in accordance with an embodiment of the present disclosure.

FIG. 2 shows aspects of an example intake passage and an example EGR system in accordance with an embodiment of the present disclosure.

FIG. 3 illustrates aspects of a method operating an engine in accordance with an embodiment of the present disclosure.

### DETAILED DESCRIPTION

The systems, devices and approaches disclosed and described below outline various examples of introducing EGR gas in an intake passage of an engine system via multiple EGR inlets. The location of the EGR inlets, as well as the spacing, size and shape of the EGR inlets in relation to each other and various engine elements and components may lead to various improvements in EGR gas mixing. Such an approach is particularly advantageous in engines having a plurality of cylinders with one or more donor cylinders dedicated to EGR, such as for engines in locomotive, marine, stationary power plant, and/or Off-Highway Vehicle (OHV) applications.

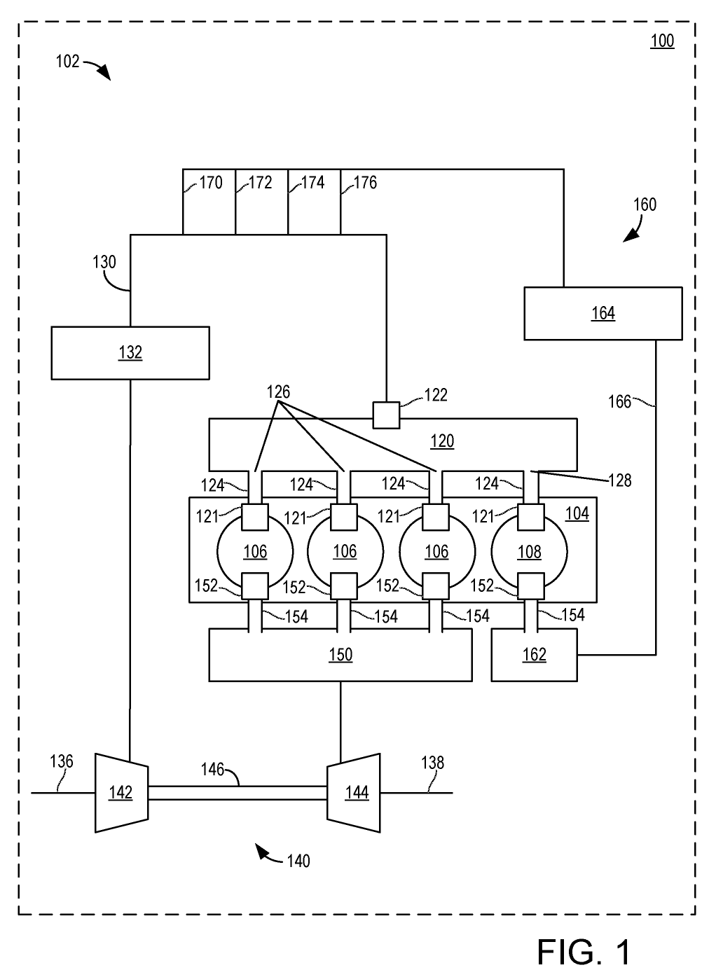

FIG. 1 shows an example engine system 102 coupled in a device 100. In one example, device 100 may be a locomotive. However, as noted above, device 100 may alternatively be a ship/marine vessel, stationary power plant, OHV, or other devices.

As one example, the illustrated configuration of engine system 102 includes an engine 104, an intake manifold 120, an intake passage 130, a turbocharger 140, a first exhaust manifold 150, a second exhaust manifold 162, and an EGR system 160. In additional configurations of system 102, turbocharger 140 is not included. In some examples, system 102 further includes optional charge air cooler 132 and optional EGR cooler 164.

Intake manifold 120 supplies fresh air to the engine 104. Intake manifold 120 has an inlet 122, and at least one outlet coupled to the engine 104. Inlet 122 may include a throttle in some examples. In the present example first outlets 126 are coupled to a first cylinder group 106 and a second outlet 128 is coupled to a second cylinder group 108. The intake manifold 120 is coupled to the totality of cylinders of the engine 104 via intake runners 124.

Further, the intake passage 130 is coupled to the inlet 122 of the intake manifold 120. Intake passage is coupled to air induction passage 136 to receive air from the environment. Air from the air induction passage 136 may have passed through an air filter, and/or other intake system components. In some examples, a throttle is disposed between the air induction passage 136 and intake passage 130. Intake passage 130 is also shown coupled to a compressor 142 (part of turbocharger 140 described below) and in the present example, intake passage 130 enables fluid communication between the intake manifold 120 and the compressor 142. In some examples, intake passage 130 includes a bypass connecting upstream and downstream of the compressor and including a valve disposed in the bypass to further control the effects of compressor 142 on the flow of fresh air to the engine.

In the present example, turbocharger 140 is included in system 102. Turbocharger 140 includes the compressor 142 coupled to a turbine 144 so that rotation of the turbine drives the compressor 142, the compressor 142 increasing the mass of air flowing to the engine 104. Further, a charge air cooler 132 is disposed between the compressor 142 and the intake manifold 120 in the intake passage 130. In some examples, the charge air cooler 132 is in fluid communication with a liquid coolant and cools compressed air before the air is directed to the engine via the intake manifold.

Engine 104 has a first cylinder group 106 and a second cylinder group 108, with at least one cylinder in each cylinder group. The cylinders of groups 106 and 108 each include at least one intake port 121 and at least one exhaust port 152. In the present example, first cylinder group 106 includes three cylinders and second cylinder group 108 includes one cylinder. Each cylinder group 106 and 108 may be one or more cylinders. In further examples, the number of cylinders in each group may vary; however, each group 106 and 108 will have at least one cylinder. The first exhaust manifold 150 is coupled to the first cylinder group 106, and the second exhaust manifold 162 is coupled to the second cylinder group 108. The first cylinder group 106 is shown as a non-donor cylinder group with exhaust ports 152 coupled via exhaust runners 154 to the first exhaust manifold 150. Exhaust gases from the first cylinder group 106 flow from the first manifold to exhaust passage 138. Exhaust passage 138 may include exhaust gas after-treatment devices, elements and components, for example, a diesel oxidation catalyst, three-way catalyst, particulate matter trap, hydrocarbon traps, SCR catalyst system, lean NOx trap, etc. Further in the present example, exhaust gases from the first cylinder group 106 drive turbine 144 of turbocharger 140 included in exhaust passage 138 (the turbocharger 140 discussed in further detail above).

The second cylinder group 108 is shown as a donor cylinder group. When a donor cylinder group is included in the engine 104, EGR gases that are returned to the intake of the engine are derived solely from the donor cylinders. The second exhaust manifold 162, being one of at least two exhaust manifolds coupled to the engine, is a donor manifold coupled to at least one exhaust port of each of the cylinders included in the second cylinder group 108. The first exhaust manifold 150 is coupled to the exhaust ports of at least the non-donor cylinder group, but, in some examples, may be coupled to exhaust ports of the second cylinder group 108 as well. In the present example, however, the second cylinder group 108 is coupled exclusively to the second exhaust manifold 162 such that all exhaust gases derived from the second cylinder group 108 are directed from exhaust port 152 via an exhaust runner 154 to only the second exhaust manifold 162.

System 102 further includes an EGR system 160. In some examples, second exhaust manifold 162 is located within EGR system 160. In additional examples, EGR system 160 is coupled between the second exhaust manifold and the intake passage. EGR system 160 further includes a main EGR duct 166 coupled to the donor manifold, and may optionally include an EGR cooler 164, disposed within the main EGR duct 166. In some examples, the EGR cooler 164 is in fluid communication with a liquid coolant or other coolant to cool the exhaust gases from the second cylinder group 108 as the gas is returning to the intake passage 130. Additionally, the liquid coolant may be the same coolant as supplied to the charge air cooler 132, or a different coolant.

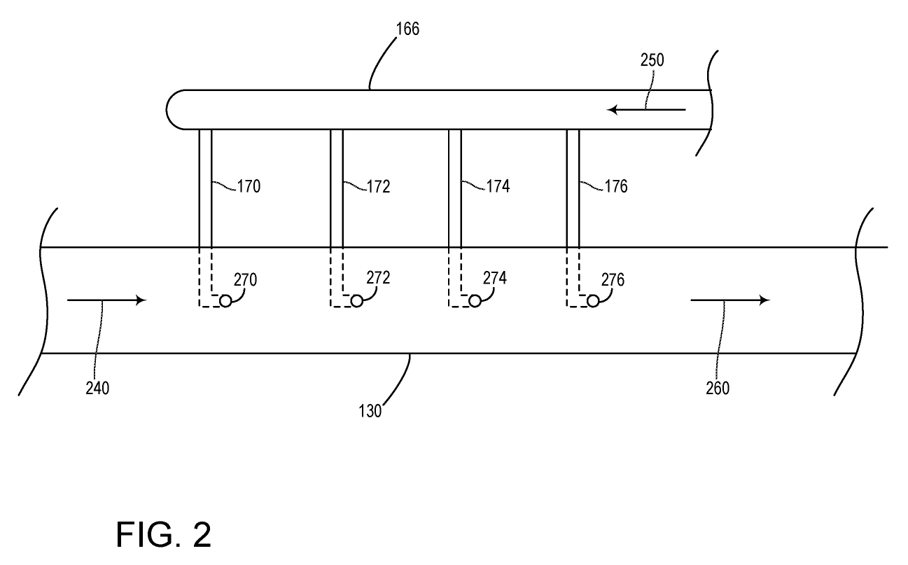

The EGR system 160 further includes a plurality of EGR inlets 170, 172, 174, and 176 coupled to the intake passage 130. FIG. 2 shows the EGR inlets 170, 172, 174 and 176 in greater detail. Each EGR inlet 170, 172, 174, and 176 is further coupled to the main EGR duct 166 to direct EGR gas to the engine 104. Each EGR inlet has an opening, 270, 272, 274 and 276, respectively. The openings 270, 272, 274 and 276 each have an individual profile (i.e., “inlet profile”), the profile being a size and shape of the EGR inlet collectively defining a cross-sectional area of an interior of the opening where each respective EGR inlet 170, 172, 174, and 176 meets the intake passage 130.

When air pressure from air at 240 entering the intake passage is greater than that of the gas at 250 entering the EGR inlets, mixing of fresh air and EGR gas may be impaired. One example of engine conditions that lead to such poor EGR mixing conditions may include high engine loads and low engine speeds. For example, a low engine speed may be an engine speed below a threshold speed (e.g., 1500 RPM), and a high engine load may be an engine load above a threshold load. As a result, air at 260 entering the intake manifold 120 may be unevenly mixed, or may not include a desired amount of EGR gas. A reduction in EGR gas at 260 entering the intake manifold leads to a buildup of backpressure in the second cylinder group 108 in one example, as well as increased combustion temperatures with the engine 104 and increased NOx emissions in further examples.

Various rules and strategies may be used individually or in combination to increase the mixing of EGR gas from inlets 170, 172, 174, and 176 into the intake passage 130, upstream of intake manifold 120 so that air at 260 that enters the intake manifold is well mixed and includes a desired amount of EGR gas. In a first example, the profile of each opening 270, 272, 274 and 276 has a cross-sectional area and the cross-sectional area further defines, in part, a flow volume. Flow volume in the present example is how much air leaves the EGR system 160 and flows through a given opening into the intake passage 130, per unit time. In one example, to increase the mixing of EGR gas with fresh air, a first opening has a profile allowing a first flow volume and a second opening has a profile allowing a second flow volume, the first flow volume being an integer multiple of a second flow volume. In one such example, opening 270 allows a flow volume that is twice the flow volume of opening 272 (i.e., the integer multiple in this case is two). By increasing the flow volume of inlet 270 relative to inlet 272, more EGR may be introduced into the intake passage upstream of the intake manifold 120, leading to increased mixing of fresh air at 240 and EGR gas 250.

In addition, though the present example shows four inlets 170, 172, 174 and 176, further examples include differing numbers in EGR inlets. In general, the EGR system 160 has a number of openings positioned within the intake passage 130, the number of openings equal to or greater than a number of cylinders having an intake event between successive exhaust events occurring in the second cylinder group.

For example, the number of EGR inlets may be equal to or greater than the number of cylinders pulling in intake air between successive exhaust pulses from the group of donor cylinders (e.g., second cylinder group) to the donor manifold. As shown in FIG. 1, engine 104 has four cylinders. In some examples, the engine has a firing order where each cylinder of the engine fires once in 720 degrees of crankshaft rotation, and thus each cylinder of groups 106 and 108 fires once before any cylinder fires a successive time. In such an example, there are four cylinders pulling in intake air (four intake events) between each exhaust pulse (exhaust event) from the single cylinder of donor cylinder group 108. Hence, the resulting example includes at least four EGR inlets and openings. In a further embodiment not shown, engine 104 includes twelve cylinders, with first cylinder group 106 comprising nine cylinders and second cylinder group 108 comprising three cylinders. If an exhaust pulse from the second cylinder group 108 occurs every 240 crankshaft angle degrees, then again, four or more EGR inlets would be suitable, as four intake events occur between each exhaust event of the donor cylinder group.

In addition to the number of EGR inlets and the flow volume of each inlet, the spacing between EGR openings in the intake passage 130 affects the mixing of EGR gas 250 with fresh air at 240. Spacing the openings 270, 272, 274, and 276 too close together may result in poor mixing, whereas spacing the openings too far apart may be undesirable due to packaging space concerns dictated by device 100. In the present example, the spacing between each opening is a constant interval. In some examples the size of an interval between openings and a cross-sectional area of the intake passage 130 between each opening is equal to a volume of a cylinder of the engine 104 (i.e., size of interval*cross-sectional area=volume of engine cylinder). Similarly, spacing of the EGR inlets in the main EGR duct may be structured in the same way. In such further examples, a volume of main EGR duct 166 is chosen so that the volume of the main EGR duct 166 between each EGR inlet is equal to the volume of one cylinder of the engine 104. Further, the flow volume of each opening 270, 272, 274, and 276 may be the same in examples where the spacing between each opening is a constant interval. In some such examples, the flow volume of each opening is equal to the volume of one cylinder of the engine 104. In this way, the openings 270, 272, 274 and 276 are spaced and sized to be tuned to improve mixing of EGR gas with fresh air.

However, in additional examples, the spacing between openings 270, 272, 274, and 276 is irregular, such that at least one interval (i.e., distance) between each successive EGR inlet is different. In some such examples, the mixing of EGR gases with fresh air is better accomplished because the gas introduced by one opening interferes less with the gas introduced by further openings. In some examples, there is a first interval between successive openings 270 and 272, and this first interval is different than a second interval between openings 272 and 274. In one such example, a third interval between 274 and 276 is the same as the second interval. In other examples, the intervals between each successive pair of openings is different so that resonance phenomena and harmonics of intake passage 130 and main EGR duct 166 do not deter EGR gas from mixing with fresh air. In such examples, the first interval is different from the second interval and the third interval is an interval different from that of both the first and second intervals.

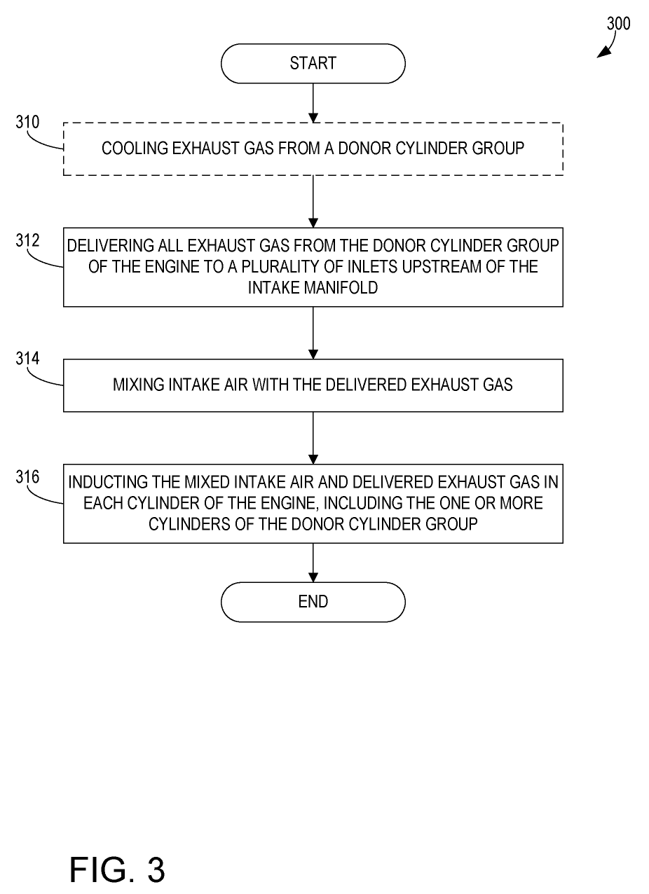

Turning now to FIG. 3, a method 300 is shown, the method 300 for operating an example engine. In some examples, the method may include operating an engine system, such as that described above with reference to FIGS. 1 and 2. As illustrated by the dashed lines at 310, the present example method optionally includes cooling exhaust gas from a donor cylinder group. In further examples of the method, cooling is not included, either because an engine is to be operated with warm EGR gases as part of an engine warming method, or because the devices and elements carrying out the method do not include an EGR cooler.

Next, at 312, the method 300 includes delivering all exhaust gas from the donor cylinder group of the engine to a plurality of inlets upstream of the intake manifold. As discussed above, the donor cylinder group has one or more cylinders. Further as discussed above, in some examples, the delivering of exhaust gas from the donor cylinder group takes place according to a firing order of the engine.

Further, the method 300 includes at 314 mixing intake air with the delivered exhaust gas. As described above, the mixing of exhaust gas delivered by the inlets is improved, in some examples by the size, number, and relative location of the inlets. In one such example, an interval between each of the plurality of inlets and a cross-sectional area of an intake passage where the inlets deliver exhaust gas collectively define a volume of one cylinder of the engine. In such an example, the inlets may be said to be tuned to improve exhaust gas mixing.

Next, at 316 the method 300 includes inducting mixed intake air and delivered exhaust gas in each cylinder of the engine, including the one or more cylinders of the donor cylinder group. Further, a number of the inlets are equal to or greater than a number of cylinders of the engine having induction events between successive donor cylinder exhaust events occurring in the donor cylinder group. In some examples, after 316 the method may end, as presently shown.

By including the above described structures and methods relating to among other elements and features, the size, number, and relative location of the multiple EGR inlets 170, 172, 174 and 176, the above described system 102 achieves uniform EGR distribution to all cylinders, even with varying inlet air and EGR flow to the engine.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system comprising:
an engine having at least a first cylinder group and a second cylinder group, with at least one cylinder in each cylinder group;
an intake manifold having an inlet and a first outlet coupled to the first cylinder group and a second outlet coupled to the second cylinder group;
an intake passage coupled to the intake manifold inlet;
a first exhaust manifold coupled to the first cylinder group, and a second exhaust manifold coupled to the second cylinder group; and
an exhaust gas recirculation system coupled between the second exhaust manifold and the intake passage, the exhaust gas recirculation system having a number of openings positioned within the intake passage, the number of openings equal to or greater than a number of cylinders having an intake event between successive exhaust events occurring in the second cylinder group.

2. The system of claim 1, wherein the second cylinder group is coupled exclusively to the second manifold.

3. The system of claim 1, wherein a spacing between the openings positioned within the intake passage is a constant interval.

4. The system of claim 1, wherein a spacing between a first successive pair of the openings positioned within the intake passage is a first interval and a spacing between a second successive pair of the openings is a second interval, the second interval not equal to the first interval.

5. The system of claim 1, further comprising an interval between a first of the openings of the exhaust gas recirculation system and a second, successive one of the openings of the exhaust gas recirculation system, wherein the interval between the first and second openings and a cross-sectional area of the intake passage is equal to a volume of a cylinder of the engine.

6. The system of claim 1, wherein each of the openings comprises a size and a shape collectively defining a profile having a cross-sectional area, the cross-sectional area further defining a flow volume, and wherein a first of the openings has a profile allowing a flow volume twice as large as a second of the openings.

7. The system of claim 1, wherein the engine is coupled in a locomotive.

8. The system of claim 1, wherein the engine is coupled in a ship.

9. The system of claim 1, wherein the engine is coupled in a stationary power plant.

10. The system of claim 1, wherein the engine is coupled in an off-highway vehicle.

11. A system comprising:
an engine comprising two groups of cylinders, with at least one cylinder in each group, the cylinders each comprising an intake port and an exhaust port, wherein one of the two groups of cylinders is a donor cylinder group and wherein the other of the two groups of cylinders is a non-donor cylinder group;
a turbocharger, including a compressor coupled to a turbine so that rotation of the turbine drives the compressor, the compressor increasing the mass of air flowing to the engine;
an intake manifold, coupled to the totality of cylinders of the engine via intake runners;
an intake passage, coupled to the compressor and the intake manifold for enabling fluid communication therebetween;
a charge air cooler, disposed between the compressor and the intake manifold, the charge air cooler in fluid communication with a liquid coolant;
a first exhaust manifold, coupled to the exhaust ports of at least the non-donor cylinder group; and
an exhaust gas recirculation system further comprising,
a second exhaust manifold, the second exhaust manifold being a donor manifold coupled to the exhaust ports of the cylinders included in the donor cylinder group,
a main exhaust gas recirculation duct, coupled to the donor manifold,
an exhaust gas recirculation cooler, disposed within the main exhaust gas recirculation duct, the exhaust gas recirculation cooler in fluid communication with the liquid coolant or another coolant, and
a plurality of exhaust gas recirculation inlets, the plurality of exhaust gas recirculation inlets coupled to the intake passage, each exhaust gas recirculation inlet being further coupled to the main exhaust gas recirculation duct to direct exhaust gas recirculation gas to the engine, the exhaust gas recirculation inlet having an inlet profile, the inlet profile being a size and shape of the exhaust gas recirculation inlet collectively defining a cross-sectional area of an interior of an opening between the inlet and the intake passage;
wherein the number of exhaust gas recirculation inlets is equal to or greater than the number of cylinders pulling in intake air between successive exhaust pulses from the donor cylinder group to the donor manifold.

12. The system of claim 11, wherein the cylinders of the donor cylinder group are coupled exclusively to the second exhaust manifold.

13. The system of claim 11 wherein the spacing between a first pair of exhaust gas recirculation inlet openings positioned within the intake passage is a first interval and the spacing between a second pair of openings is a second interval, not equal to the first interval.

14. The system of claim 11, wherein a spacing between exhaust gas recirculation inlet openings positioned within the intake passage is a constant interval.

15. The system of claim 11, coupled into a vehicle or a stationary power plant.

16. The system of claim 11, wherein the cross-sectional area of the inlet profile further defines a flow volume of air leaving the exhaust gas recirculation system and entering the intake passage, and wherein a first opening has a profile allowing a first flow volume and a second opening has a profile allowing a second flow volume, the first flow volume being an integer multiple of the second flow volume.

17. The system of claim 16, wherein the integer multiple is two.

18. A method of operating an engine having an intake manifold, comprising:
delivering all exhaust gas from a donor cylinder group of the engine to a plurality of inlets upstream of the intake manifold, the donor cylinder group having one or more cylinders;
mixing intake air with the delivered exhaust gas; and
inducting the mixed intake air and delivered exhaust gas in each cylinder of the engine, including the one or more cylinders of the donor cylinder group, wherein a number of the inlets is equal to or greater than a number of cylinders of the engine having induction events between successive donor cylinder exhaust events occurring in the donor cylinder group.

19. The method of claim 18 further comprising cooling the exhaust gas from the donor cylinder group before the delivering.

20. The method of claim 19, wherein an interval between each of the plurality of inlets and a cross-sectional area of an intake passage where the inlets deliver exhaust gas collectively define a volume of one cylinder of the engine.
